(19) United States
(12) Patent Application Publication
(10) Pub. No.: US 2008/0015977 A1
(43) Pub. Date: Jan. 17, 2008

(54) METHODS OF DETERRING FRAUD AND OTHER IMPROPER BEHAVIORS WITHIN AN ORGANIZATION

(76) Inventors: Edith L. Curry, Glen Allen, VA (US); Frank Hailstones, Orlando, FL (US); Michael A. Dement, Williamsburg, VA (US); Laurie S. Holtz, Miami Beach, FL (US)

Correspondence Address: HAHN LOESER & PARKS, LLP, One GOJO Plaza, Suite 300, AKRON, OH, 44311-1076, US

(21) Appl. No.: 11/424,086

(22) Filed: Jun. 14, 2006

(51) Int. Cl. G06Q 40/00

(52) U.S. Cl. 705/38

(57) ABSTRACT

A cooperative arrangement and method to help deter fraud and other improper behaviors by an individual in an organization are disclosed. A personal financial disclosure statement, personal financial records, and other relevant financial data associated with an individual who is associated with, or to be associated with, the organization are obtained. Information is extracted from the personal financial disclosure statement, the personal financial records, and the other relevant financial data and input into a risk assessment algorithm. The risk assessment algorithm operates on the input information and generates risk assessment data. The risk assessment data is evaluated to make a determination of risk certification with respect to the individual. A decision to certify means that the risk associated with the individual, with respect to committing fraud or some other improper act with respect to the organization, is acceptable. Risk assessment data on a plurality of key individuals within the organization may be generated and evaluated to make a determination of risk certification with respect to the organization as a whole.

### TECHNICAL FIELD

Certain embodiments of the present invention relate to organizational behavior such as, for example, behavior of an individual when operating within a legal entity such as a corporation. More particularly, certain embodiments of the present invention relate to methods of deterring fraud and other improper behaviors within an organization by reducing the risks of financial self-dealing and self-enrichment associated with the people who are responsible for various aspects of the organization.

### BACKGROUND OF THE INVENTION

Corporate fraud is perpetrated by individuals, and a leading fraud indicator is the individual's personal financial behaviors. How an individual earns, saves, invests, manages, and spends money are key factors. Typically, fraud and embezzlement begins with the individual telling himself, “ . . . just this once, I'll pay it back.” But once that line is crossed, the individual rarely turns back. It becomes easier and easier, with the amount embezzled steadily increasing before being detected, if at all.

The core of the problem is a breach of fiduciary duty by the trustees of the investors' interests (i.e., the board of directors and management). A passive, non-independent, and rubber-stamping board of directors made up of members selected by the CEO or chairman of the board is not a guarantee of effective oversight of management actions and conduct.

However, management teams that place personal interests above investor demand for value creation when conducting the affairs of the corporation incur a systemic conflict of interest. In the past, breaches of fiduciary duty by management and boards of directors were sometimes condoned by auditors who lacked independence and possessed limited capability and authority to challenge management.

The Sarbanes-Oxley Act (SOA), signed into law on Jul. 30, 2002 was designed to protect America's shareholders and workers and gave the Federal Government new powers to enforce corporate responsibility and to improve oversight of corporate America. This legislation gave new power to prosecutors and regulators seeking to improve corporate responsibility and protect America's shareholders and workers. Among other reforms, the legislation:
created a new accounting oversight board to police the practices of the accounting profession;
strengthened auditor independence rules;
increased the accountability of officers and directors;
enhanced the timeliness and quality of financial reports of public companies;
barred insiders from selling stock during blackout periods when workers are unable to change their 401(K) plans;
created a new securities fraud provision with a 25-year maximum term of imprisonment;
directed the Sentencing Commission to review sentencing in white collar crime, obstruction of justice, securities, accounting, and pension fraud cases;
required CEOs and Chief Financial Officers (CFOs) to personally certify that financial reports submitted to the SEC fully comply with the securities laws and fairly present, in all material respects, the financial condition of the company;
made it a crime to willfully certify any such financial report knowing the same to be false or non-compliant, punishable by up to 20-years in prison;
criminalized the alteration or falsification of any document with the intent to obstruct the investigation of any matter within the jurisdiction of a United States Department or Agency;
criminalized retaliatory conduct directed at corporate whistleblowers and others; and
required that audit papers be retained for five years and criminalized the failure to maintain such records.

There is a great debate about Section 404 of Sarbanes-Oxley which is the provision that requires that auditors and management attest to the internal controls of publicly traded corporations. The debate concerns whether the costs of Section 404 exceed the benefits. While everyone debates the cost-benefit analysis of Section 404, there is a broad consensus that the rules are not cost-effective. In other words, the rules have been adopted and implemented in such a way that companies are forced to spend money beyond the point at which the marginal benefits of the expenditures exceed the marginal costs of the expenditures.

Congress could consider narrowing some parts of the Sarbanes-Oxley Act and broadening others. Since passage of the Sarbanes-Oxley Act in 2002, there has been time to learn what is working and what is not working. Laws and regulations could be refocused on people rather than procedures. Congress could allow for the development of market-based solutions, which are more likely to have a positive cost-benefit for companies and shareholders.

The Sarbanes-Oxley Act places considerable emphasis on correcting lax corporate governance practices, including:
management dealing in an environment full of pervasive conflicts of interest;
lack of strict transparency, reliability, and accuracy standards in financial reporting;
lack of independence between the key players in corporate governance, beginning with the board of directors, senior management, and auditors;
lack of adequate enforcement tools for regulators; and
widespread conflicts of interest influencing securities market transactions.

Addressing the systemic weakness of the corporate governance practices in the post-Sarbanes-Oxley corporate environment requires more than correcting the most visible manifestations of the problem. Weak governance practices are the combined result of several offenders and lax controls over the performance of both management and the board of directors.

Laws and regulations have never been sufficient to guarantee society's welfare or, in this case, improvement in corporate governance standards. In many ways, Sarbanes-Oxley has merely made express the duties and responsibilities of boards, CEOs, and CFOs and taken away from them the ability to point a finger at someone else if fraud and abuse occur at a company covered by Sarbanes-Oxley. However, these duties existed before Sarbanes-Oxley was enacted albeit in less explicit fashion. While it may be comforting to some that Sarbanes-Oxley has eliminated the ability of senior management to claim they did not know or were not aware, this is still unlikely to prevent people from committing the types of fraud and abuse that led to the passage of Sarbanes-Oxley in the first place.

While Sarbanes-Oxley, in its current or future form, will play a necessary role in ensuring that U.S. companies avoid certain excesses, the market and investors should continue to seek out solutions that are driven by market needs that help restore and maintain the confidence of investors in public companies.

Accountability is the key. The owners of America's corporations (i.e., the stockholders) must hold managers, directors, auditors, and market participants accountable. The performance of these groups directly impacts shareholder value. The corporate governance process must be re-engineered into one that guarantees performance excellence by management and the board of directors when performing their agency duties as trustees of shareholder confidence.

Although implementing corporate governance best practices can result in additional operating costs, good corporate governance is not an option but an obligation, if shareholder interest is to be protected. Compliance costs are only a small fraction of the large losses suffered by stockholders because the board and/or executive management did not comply with good corporate governance practices. Sarbanes-Oxley has taken great steps at ensuring proper corporate governance and has put some teeth into board and management penalties for non-compliance.

One way in which a director or officer can be protected from personal financial loss is to purchase director and officer liability. This coverage is typically purchased by corporations to cover their directors and officers against lawsuits filed against them for their actions in their professional capacities as directors or officers of the company.

Most Director and Officer (D&O) insurance policies are similar in several important ways. All D&O policies are designed to provide directors and officers with coverage for lawsuits or claims alleging the commission of one or more “wrongful acts” in the scope of the director's or officer's professional duties. If a covered claim is made, D&O policies also provide for reimbursement of defense costs incurred in defending that claim, and indemnification for any judgment or settlement in the case.

However, given the jurisdiction-to-jurisdiction and policy-to-policy differences, with respect to coverage for deliberate fraud and criminal acts, corporations are discovering that once fraud is detected, it is likely not covered, leaving the company and its board members even more exposed to the inevitable shareholder class-action suit.

Even if a company can establish that it is entitled to coverage under its existing D&O coverage, the best the company can hope for is that all or some of the direct costs/losses to the company will be recovered. However, D&O coverage is only reactive. Other than the extent to which premiums may be based upon the past history or current governance of the company, D&O insurance does little to actually prevent fraud from occurring. Given the consequences to a company's share prices and overall reputation once fraud is publicly revealed, particularly given the mandates of Sarbanes-Oxley around disclosing fraud, a more proactive solution is needed.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

A first embodiment of the present invention comprises a method to help deter fraud within an organization. The method includes obtaining a personal financial disclosure statement of an individual person associated with or potentially to be associated with the organization and also obtaining personal financial records and other relevant financial data of the individual person. The method further includes inputting first information from the personal financial disclosure statement, the personal financial records, and the other relevant financial data into a risk assessment algorithm. The method also includes the risk assessment algorithm operating on the first input information and thereby generating first risk assessment data. The method further includes evaluating the first risk assessment data and thereby making a first determination of risk certification with respect to the individual person.

A second embodiment of the present invention comprises a method to help deter fraud within an organization. The method comprises obtaining a personal financial disclosure statement, personal financial records, and other relevant financial data for each of a plurality of individual persons associated with the organization. The method further comprises inputting first information from each of the personal financial disclosure statements, each of the personal financial records, and each of the other relevant financial data into a risk assessment algorithm. The method also comprises the risk assessment algorithm operating on the first input information and thereby generating first risk assessment data. The method further comprises evaluating the first risk assessment data and thereby making a first determination of risk certification with respect to the organization.

A third embodiment of the present invention comprises a method to monitor an individual person of an organization for behavioral risk. The method includes periodically obtaining updated personal financial records and other relevant financial data of an individual person that is currently certified for risk with respect to the organization. The method further includes inputting, into a risk assessment algorithm, updated information from the updated personal financial records and other relevant financial data along with previous information from a previously obtained personal financial disclosure statement of the individual person. The method also includes the risk assessment algorithm operating on the input information and thereby generating updated risk assessment data. The method further includes evaluating the updated risk assessment data and thereby making an updated determination of risk certification with respect to the individual person.

All individuals who are in a position of materially affecting the financial performance or assets of an organization can apply for certification, in accordance with an embodiment of the present invention. The individual completes a financial disclosure statement and gives the certifying entity permission to review their financial behaviors for, for example, the past 5 to 10 years depending on position(s) held. If the employee meets the strict risk criteria, they are certified. Such a certification process helps to drive the right behaviors of individuals.

If, at any time during the certification period, issues of concern are identified, the corresponding event is investigated for accuracy, the individual is notified and, depending on the results of the investigation, certification may be suspended, cancelled, re-rated, or left unchanged. The certification entity, in accordance with an embodiment of the present invention, is an independent evaluator of risk. The oversight and independent monitoring of key individuals are provided, thus identifying those most likely to be a fraud risk. Certain embodiments of the present invention use risk models which are based on a complex algorithm of predictive financial modeling, and not on biographical data which could be used for profiling.

These and other advantages and novel features of the present invention, as well as details of illustrated embodiments thereof, will be more fully understood from the following description and drawings.

### BRIEF DESCRIPTION OF SEVERAL VIEWS OF THE DRAWINGS

FIG. 1 is a functional block diagram of an embodiment of a cooperative arrangement to help deter fraud within an independent organization, in accordance with various aspects of the present invention.

FIG. 2 illustrates a flowchart of a first embodiment of a method to help deter fraud within an independent organization using the cooperative arrangement of FIG. 1, in accordance with various aspects of the present invention.

FIG. 3 illustrates a flowchart of a second embodiment of a method to help deter fraud within an independent organization using the cooperative arrangement of FIG. 1, in accordance with various aspects of the present invention.

FIG. 4 illustrates a flowchart of an embodiment of a method to monitor an individual of an independent organization for risk using the cooperative arrangement of FIG. 1, in accordance with various aspects of the present invention.

### DETAILED DESCRIPTION OF THE INVENTION

As used herein, the term “agent” refers to any individual person in a position of responsibility and trust with respect to an organization, including but not limited to an officer of the organization, an employee of the organization, a member of the board of directors of an organization, a major stockholder of the organization, and anyone who has the ability to over-ride proper governance, policies, procedures, and controls of the organization. As used herein, the term “risk” generally refers to the risk associated with the likelihood of an agent to commit fraud or some other improper act with respect to the organization.

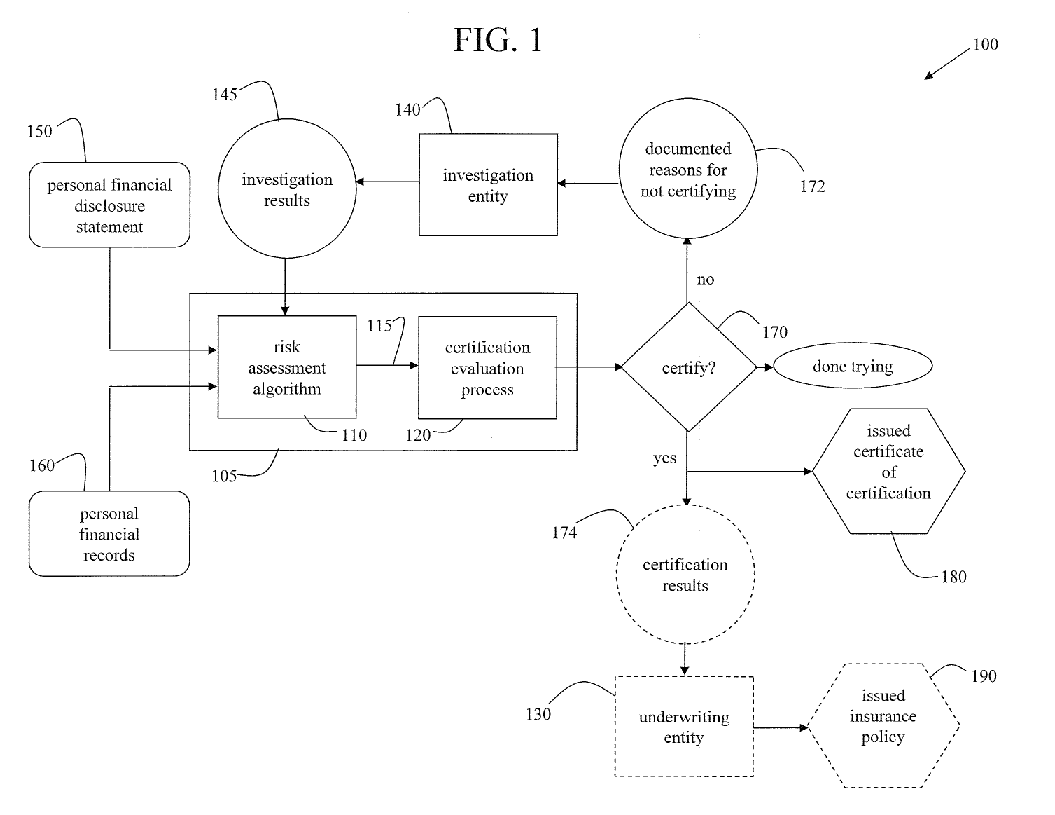

FIG. 1 is a functional block diagram of an embodiment of a cooperative arrangement 100 to help deter fraud within an independent organization, in accordance with various aspects of the present invention. The cooperative arrangement 100 comprises a certification entity 105 which includes a risk assessment algorithm 110 and a certification evaluation process 120. The cooperative arrangement 100 further comprises an underwriting entity 130, as an option, and an investigation entity 140. The risk assessment algorithm 110 is adapted to accept information from at least one personal financial disclosure statement 150 and at least one set of personal financial records 160 and other relevant financial data. Each personal financial disclosure statement 150 and each set of personal financial records 160 and other relevant financial data is associated with one individual person (e.g., an agent of the independent organization). In accordance with certain embodiments of the present invention, the agent has the choice to proceed or not with the certification process. That is, the agent may or may not give his informed consent to engage in the certifying process and may or may not give permissive use of his financial records and data.

In accordance with an embodiment of the present invention, the certifying entity 105 is independent of both the individual persons to be certified and the independent organization. The risk assessment algorithm 110 operates on the input information from the personal financial disclosure statement(s) 150 and the set(s) of personal financial records 160 and other relevant financial data and generates risk assessment data 115. The risk that is being assessed is the likelihood that an individual person (i.e., agent) will attempt to commit fraud or other improper actions against the independent organization. The risk assessment data 115 is input to the certification evaluation process 120. The certification evaluation process 120 evaluates the risk assessment data 115 to make a determination of risk certification 170 with respect to one of an individual person (e.g., an agent of the independent organization) or to the independent organization itself.

If the determination of risk certification 170 is “yes” (i.e., to certify), then a formal certificate of certification 180 is issued (i.e., the paperwork, record, or computer file verifying that the person is certified), for the individual person or the independent organization. As an option, the underwriting entity 130 is used to conduct an underwriting procedure. That is, the underwriting entity 130 is used to generate and issue, or update, an insurance policy or fidelity bonding policy 190 in response to the certification results 174 of the evaluation process 120. For example, the certified agent may be added to the policy. When the decision is “to certify”, the certification entity 105 is saying that the risk associated with the agent, with respect to committing fraud or some other improper act with respect to the organization, is acceptable. If the determination of risk certification 170 is “no” (i.e., not to certify), then documented reasons for not certifying 172 are generated and forwarded to the investigation entity 140.

In accordance with an embodiment of the present invention, the investigation entity 140 performs an investigation based on the documented reasons for not certifying 172 and generates a set of investigative results 145. Information from the investigative results 145 may be input back into the risk assessment algorithm 110, along with the personal financial disclosure statement 150 and the set of personal financial records 160 and other relevant financial data to generate a second set of risk assessment data 115 (i.e., investigation-based risk assessment data). As part of the investigation, the investigative entity 140 may ask for additional information from the agent to be certified, or may wish to interview the agent to be certified.

The second risk assessment data 115 is input to the certification evaluation process 120. The certification evaluation process 120 evaluates the second risk assessment data 115 to make a new investigated determination of risk certification 170 with respect to one of an individual person (e.g., an agent of the independent organization) or the independent organization itself. Based on the additional information from the investigative results 145, the second risk assessment data 115 and, therefore, the new determination of risk certification 170 may be the same as (i.e., “no”) or different from (i.e., “yes”) the original determination of risk certification 170. As a practical matter, there may be a limit to the number of times that a result of “no” or “do not certify” will be investigated. That is, at some point, the attempts to certify the agent will be stopped.

In accordance with an alternative embodiment of the present invention, financial records and other relevant financial data of other persons associated with the agent to be certified may be obtained and input into the risk assessment algorithm 110 along with the information from the agent to be certified. Such other persons may include, for example, a spouse, a child, or a parent of the agent to be certified. Such information of other persons may be helpful if, for example, an unscrupulous individual were to try to hide embezzled funds in an account that is in the name of a close relative.

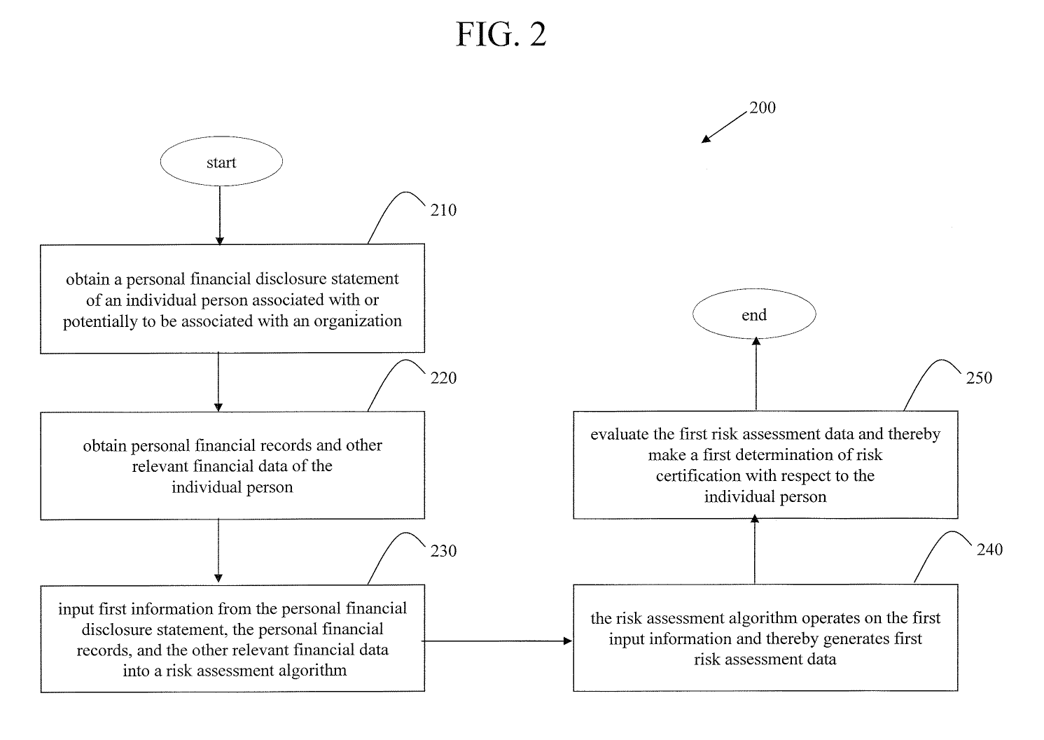

FIG. 2 illustrates a flowchart of a first embodiment of a method 200 to help deter fraud within an independent organization using the cooperative arrangement 100 of FIG. 1, in accordance with various aspects of the present invention. In step 210, a personal financial disclosure statement of an individual person, associated with or potentially to be associated with an organization, is obtained. In step 220, personal financial records and other relevant financial data of the individual person are obtained. In accordance with an embodiment of the present invention, step 220 is performed only if the individual person gives permission. In step 230, first information from the personal financial disclosure statement, the personal financial records, and other relevant financial data is input into a risk assessment algorithm. In step 240, the risk assessment algorithm operates on the first input information and thereby generates first risk assessment data. In step 250, the first risk assessment data is evaluated to make a first determination of risk certification with respect to the individual person. In accordance with an alternative embodiment of the present invention, only information from personal financial records and other relevant financial data are used. A personal financial disclosure statement is not obtained.

As an example, referring to FIG. 1, an agent of a corporation is to be certified for risk by the certification entity 105. In accordance with an embodiment of the present invention, the certification entity 105 is an independent entity which is in the business of certifying individual agents of other independent organizations (e.g., publicly held corporations, non-publicly held corporations, government entities), for example. Such risk certification helps to ensure that the agent being certified is likely to comply with policies, procedures, and controls of the organization such as, for example, complying with Sarbanes-Oxley regulations. Such risk certification also helps to ensure that the agent being certified is likely to not engage in fraudulent activities such as, for example, embezzlement of funds, or other improper behaviors.

Continuing with the example, the agent registers with the certifying entity 105 and provides a personal financial disclosure statement 150 to the certification entity 105. Information provided on the personal financial disclosure statement may include, for example, information related to assets (e.g., home ownership), and liabilities (e.g., credit card debt) of the agent as well as income (e.g., a salary). The agent also gives permission to the certification entity 105 to obtain past and most-recent personal financial records 160 and other relevant financial data such as, for example, tax return records, treasury records, real estate records, banking records, a credit report, and a Fair Isaac Company (FICO) score.

Information is extracted from the personal financial disclosure statement 150 and the personal financial records 160 and other relevant financial data and is input into the risk assessment algorithm 110. The risk assessment algorithm 110 operates on the input information and generates risk assessment data 115. The risk assessment data 115 may include, for example, detected discrepancies found when comparing the agent's personal financial disclosure statement 150 and the personal financial records 160. For example, an income discrepancy may be found. Also, evidence of irresponsible behavior may be detected (e.g., not paying minimum balances due on credit cards), evidence of suspicious behavior may be found (e.g., an unusual transfer of funds, a sudden move or change of residence), and an assessment of financial stability may be made (e.g., an assessment of “unstable” because the bank is about to foreclose on the agent's home). Other risk assessment data are possible as well, in accordance with various embodiments of the present invention.

Next, the risk assessment data 115 goes into the certification evaluation process 120. In accordance with an embodiment of the present invention, the risk assessment data 115 is operated on by the certification evaluation process 120 to generate a composite risk factor in response to the risk assessment data 115. The composite risk factor is a reliable indicator of the agent's level of risk with respect to fraudulent or other improper activity. In accordance with an embodiment of the present invention, the composite risk factor is a single numeric value or score. The composite risk factor is compared to a threshold value which is also a numeric value.

If the composite risk factor is greater than the threshold value, then a decision to “not certify” the agent is made. If the composite risk factor is less than the threshold value, then a decision to “certify” is made. In accordance with an alternative embodiment of the present invention, if the resultant composite risk factor is within a predefined range of values about the threshold value, a decision to “delay certification” is made and further action is taken to determine if the composite risk factor can be lowered (i.e., if the risk can be reduced) in order to subsequently make a decision to “certify”. Other means of comparing a composite risk factor are possible as well, in accordance with various other embodiments of the present invention.

In accordance with an alternative embodiment of the present invention, the risk assessment algorithm 110 and the certification evaluation process 120 are implemented as a single algorithm or process. In accordance with an embodiment of the present invention, the risk assessment algorithm 110 and/or the certification evaluation process 120 are both implemented on a processor-based platform such as, for example, a personal computer (PC). In accordance with various embodiments of the present invention, the certification evaluation process 120 may be performed manually by a human, or may be performed automatically by a processor-based platform (e.g., a PC).

In the case where a decision to “certify” is made, certification results 174 may be generated and forwarded to the underwriting entity 130 as an option. In accordance with an embodiment of the present invention, the certification results 174 may include, for example, the resultant composite risk factor and the threshold value used, certain specified personal identification information of the certified agent and other certain financial information associated with the agent that were used to generate the composite risk factor. The underwriting entity 130 is typically an insurance company specializing in director and officer (D & O) underwriting or a fidelity bonding agency, in accordance with certain embodiments of the present invention, and is independent of the certification entity 105 and the investigation entity 140.

In accordance with an embodiment of the present invention, underwriting includes insuring the organization by accepting liability for designated losses arising from improper activities with respect to the organization by the agent. The underwriting entity 130 takes the certification results 174 and underwrites the organization by generating or adjusting an insurance policy or bonding policy having terms, conditions, and premium fees which are calculated in response to, at least in part, the certification results 174.

For example, if the certified agent's calculated composite risk factor is well below the threshold value, then the insurance premium fees that are to be paid for the insurance policy may be relatively low. Also, the terms and conditions of the insurance policy may be much more favorable. For example, the amount of time that can pass before the agent is to be re-certified may be longer. Also, monitoring of the agent's future personal financial activities may be less frequent. In accordance with an embodiment of the present invention, the insurance premiums are paid by the organization of the agent. As a result, the independent organization may be able to eliminate other forms of bonding and/or D & O (Directors & Officers) insurance coverage.

If new financial information is obtained for an agent and processed through the certification entity 105 and the resultant updated composite risk factor, based on the new information, is closer to the threshold value than a previously calculated composite risk factor, then the underwriting may be updated (i.e., premiums, terms and conditions may be re-calculated) as well based on the improved composite risk factor.

In the case where a decision to not certify is made, documented reasons for not certifying 172 are forwarded to the investigation entity 140. In accordance with an embodiment of the present invention, the investigation entity 140 is a private agency or entity with expertise in investigating personal financial matters of individuals. The investigation entity 130 takes the documented reasons for not certifying 172 and determines the underlying circumstances involved and generates corresponding investigation results 145.

For example, the agent's composite risk factor may be too high because the agent is seen to own shares of stock in a competing overseas corporation which constitutes, at a minimum, a conflict of interest. Upon investigation, the investigative entity 140 determines that the shares of stock were purchased for the agent as a child by his father many years ago. The agent had forgotten about the shares of stock and, therefore, failed to disclose them on his personal financial disclosure statement 150. The investigative results 145 are then forwarded to the certifying entity 105 along with a recommendation that the agent sell the problematic shares of stock. Upon selling the shares of stock, information is extracted from the investigation results 145 and input into the risk assessment algorithm 110 along with the fact that the agent no longer owns the shares of stock, and along with the information previously extracted from the agent's personal financial disclosure statement 150, personal financial records 160 and other relevant financial data.

An updated set of risk assessment results 115 are generated and an updated composite risk factor, which is substantially lower than the original composite risk factor is generated. Upon comparing the updated composite risk factor to the threshold value, a determination to “certify” the agent is made. As a result, the agent becomes certified and the underwriting process may proceed if desired.

In accordance with an embodiment of the present invention, the risk assessment algorithm 110 takes the input information and generates a set of internal parameters. The risk assessment algorithm then applies weightings to the set of internal parameters and combines the weighted internal parameters in a particular way to generate the risk assessment results 115. Certain weighted internal parameters and/or combinations of weighted internal parameters may be applied to certain internal thresholds in a certain manner to generate particular risk assessment results 115 (e.g., binary risk assessment results).

In accordance with a further embodiment of the present invention, the risk assessment algorithm 110 is an evolutionary algorithm that can evolve over time as the risk assessment algorithm 110 is presented with new input information along with truth output data corresponding to the input information. For example, information from a known first group of agents who have deliberately not complied with corporate governance rules and procedures and/or who are known to have committed fraud may be input into the risk assessment algorithm 110 along with the fact that these agents should not be certified (i.e., the algorithm should be able to adapt to generate risk assessment data 115 that detects a problem with this first group of agents with respect to risk). Similarly, information from a known second group of agents who have always complied with corporate governance rules and procedures and are known to have not committed fraud may be input into the risk assessment algorithm 110 along with the fact that these agents should be certified (i.e., the algorithm should be able to adapt to generate risk assessment data that does not detect a problem with this second group of agents with respect to risk).

Similarly, in accordance with a still further embodiment of the present invention, the certification evaluation process 120 is an evolutionary algorithm that can evolve over time as the certification evaluation process 120 is presented with new risk assessment data 115 along with truth output data corresponding to the new risk assessment data 115. For example, when presented with the risk assessment data 115 corresponding to the known agents who deliberately did not comply with corporate governance rules and procedures and who committed fraud, the certification evaluation process 120 may adapt in order to correctly generate a “do not certify” output at the certification determination step 170. Such an adaptation may involve adapting the formula for calculating the composite risk factor and/or changing the threshold value. Similarly, when presented with the risk assessment data 115 corresponding to the known agents who always complied with corporate governance rules and procedures and did not commit fraud, the certification evaluation process 120 may adapt in order to correctly generate a “certify” output at the certification determination step 170.

Typically, the risk assessment algorithm 110, the certification evaluation process 120, and the certification determination step 170 are allowed to evolve simultaneously in order to take into account the truth data presented. Such evolutionary algorithms may be implemented as, for example, genetic algorithms and/or neural network-based algorithms on processor-based platforms, in accordance with various embodiments of the present invention.

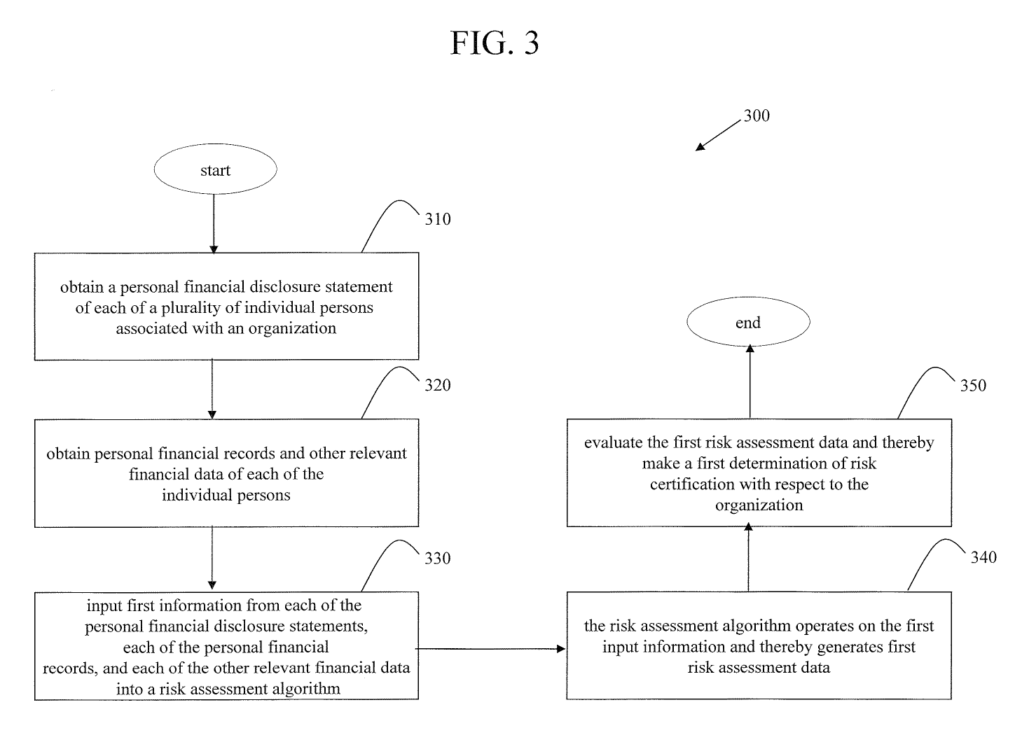

Just as a single individual can be certified (and optionally underwritten) for risk of fraud and other improper behaviors, an entire organization may also be certified (and optionally underwritten), in accordance with an embodiment of the present invention. FIG. 3 illustrates a flowchart of a second embodiment of a method 300 to help deter fraud within an independent organization using the cooperative arrangement of FIG. 1, in accordance with various aspects of the present invention. In step 310, a personal financial disclosure statement of each of a plurality of individual persons associated with an organization is obtained. In step 320, personal financial records of each of the individual persons and other relevant financial data are obtained. In step 330, first information is extracted and input from each of the personal financial disclosure statements, each of the personal financial records, and each of the other relevant financial data into a risk assessment algorithm. In step 340, the risk assessment algorithm operates on the first input information and thereby generates first risk assessment data. In step 350, the first risk assessment data is evaluated and thereby a determination of risk certification is made with respect to the organization.

Therefore, by applying the cooperative arrangement 100 of FIG. 1 to all of the agents of an independent organization that handle or have direct or even indirect input to any of the certified financial statements of the independent organization, the entire organization may become certified, and optionally underwritten, for risk of fraud and other improper behaviors, for example. Just as for an individual agent, a composite risk factor may be generated for the entire independent organization and compared to a threshold value. The underwriting and/or investigative process illustrated in FIG. 1 may be followed with respect to the entire independent organization (e.g., a publicly held corporation), based on assessing the risk associated with a plurality of agents.

Alternatively, the method 200 of FIG. 2 may simply be repeated for each of the agents of the organization and, therefore, the organization becomes certified only after each of the agents is individually certified.

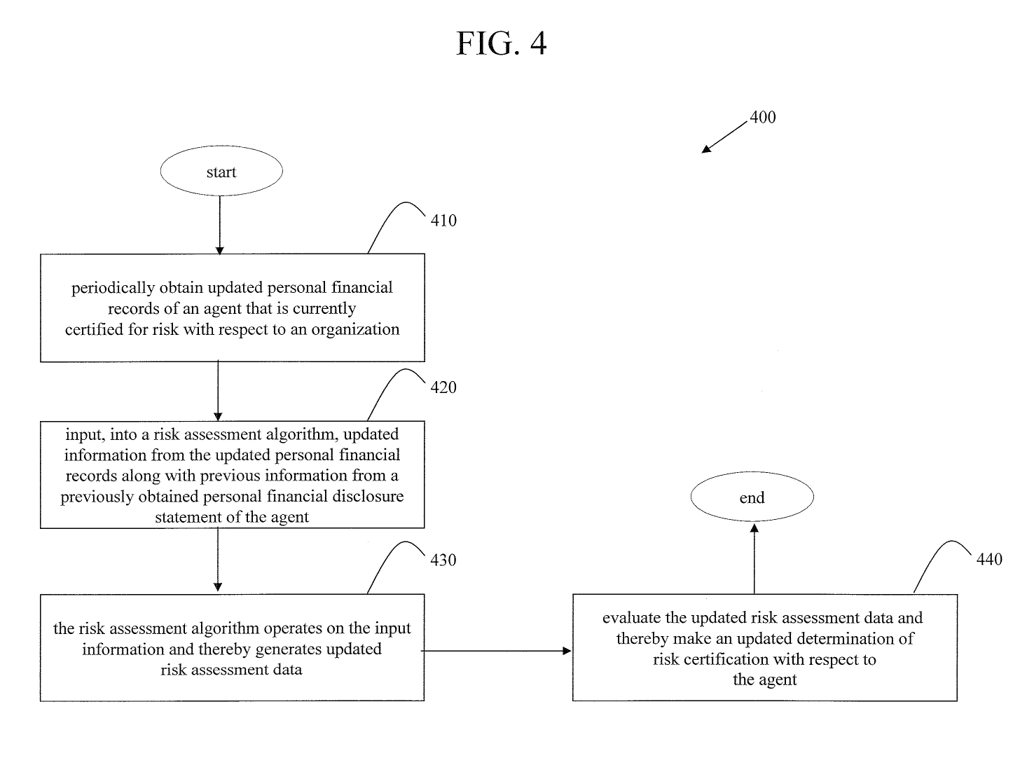

FIG. 4 illustrates a flowchart of an embodiment of a method 400 to monitor an agent of an independent organization for risk using the cooperative arrangement of FIG. 1, in accordance with various aspects of the present invention. In step 410 updated personal financial records of an agent that is currently certified for risk with respect to an organization are periodically obtained. In step 420, updated information from the updated personal financial records and other relevant financial data is input into a risk assessment algorithm along with previous information from a previously obtained personal financial disclosure statement of the agent. In step 430, the risk assessment algorithm operates on the input information and thereby generates updated risk assessment data. In step 440, the updated risk assessment data is evaluated and an updated determination of risk certification is made with respect to the agent.

For example, an agent of an independent corporation who is currently certified and covered under the organization's D&O-like policy 190 may be required to allow updated (i.e., most-recent) personal financial records to be obtained by the certifying entity 105 every fiscal quarter, in accordance with the terms of the corresponding policy 190. As a result, the certifying entity 105 is able to effectively monitor the agent to see if any significant changes in his/her personal financial status has changed that could affect the agent's risk of committing fraud or other improper activities with respect to the independent corporation. Another agent of the independent corporation may be required to provide updated personal financial records only once a year, because of the agent's superior certification status (i.e., lower composite risk factor) and superior underwriting status.

In accordance with an alternative embodiment of the present invention, the financial status of an agent may be, effectively, continuously monitored. That is, as soon as updated financial information or data for an agent becomes available, the information is immediately input to the risk assessment algorithm and processed. The agent's financial behavior is effectively tracked.

If the agent's status changes from “certify” to “do not certify”, then the investigative process previously described may be triggered and followed. As another example, if the agent's status remains “certify” but the agent's composite risk factor has changed (i.e., increased or decreased), the terms and conditions and/or premiums of the associated underwriting policy for the agent's company, if there is one, may be updated to reflect the changed risk. If no significant changes result, the previous certifying and underwriting status may be maintained.

In accordance with an alternative embodiment of the present invention, the agent may be required to provide an updated personal financial disclosure statement which is then also used in the monitoring process.

The method 400 of FIG. 4 also can also serve as a first indicator of identity theft for the monitored agent. Any unusual activity due to any form of identity theft may be detected by the certifying entity 105. For example, if the agent's credit card number is stolen and used in such a way that would be considered unusual for the agent, such an unauthorized use may be detected by the risk assessment algorithm 110.

Employees of the independent organization for which the certified agent works may be encouraged to anonymously report any observed misconduct on the part of the agent to persons in charge of the independent certifying entity 105. In this way, a reporting employee is reporting to an entity which is independent of his/her employer and, therefore, may be less reluctant to report such misconduct without fear of retaliation from the employer (i.e., from the independent organization for which the agent and the reporting employee are employed).

In accordance with an alternative embodiment of the present invention, there may be multiple levels or degrees of certification. For example, “gold”, “silver”, and “bronze” levels of certification may be defined based on ranges of possible numeric values that the composite risk factor can take on. As another example, levels of certification may be defined based on a number of years that an agent has been certified (e.g., 5-years certified, 10-years certified, etc.).

In accordance with a further alternative embodiment of the present invention, certification may be directed to particular positions within a company. For example, the composite risk factor requirement for a CEO may be different than that for a head of marketing. As another example, the exact risk assessment algorithm used may be somewhat different for a CEO than for a head of marketing.

In accordance with various embodiments of the present invention, certification may be mandatory or may be voluntary. For example, there may be an employee of an organization that is not required to be certified but would like to go through the certification process (possibly excluding the underwriting part of the process) in order to establish himself as an exemplary person of trustworthiness. Such a voluntary certification could help the employee gain a promotion into a position of higher responsibility, for example.

As another example, a private employer (i.e., not a publicly held company) may decide that all of his employees must become certified, in accordance with an embodiment of the present invention, in order to remain or become employed at his private company. That is, certification is a condition of employment. Such a mandatory pre-requisite for employment can allow the private employer to hire and retain only those people that are trustworthy.

In summary, a cooperative arrangement and methods of helping to deter fraud and other improper activities within an independent organization are disclosed. Financial information is collected for at least one individual of the independent organization and fed into a risk assessment algorithm to determine a level of risk with respect to the individual. If the level of risk is acceptable, the individual may be certified and optionally underwritten in order to protect the independent organization against any losses incurred arising from improper conduct by the individual with respect to the organization.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method to help deter fraud within an organization, said method comprising:
obtaining a personal financial disclosure statement of an individual person associated with or potentially to be associated with said organization;
obtaining personal financial records and other relevant financial data of said individual person;
inputting first information from said personal financial disclosure statement, said personal financial records, and said other relevant financial data into a risk assessment algorithm;
said risk assessment algorithm operating on said first input information and thereby generating first risk assessment data; and
evaluating said first risk assessment data and thereby making a first determination of risk certification with respect to said individual person.

2. The method of claim 1 further comprising certifying said individual person if said determination of risk certification is to certify.

3. The method of claim 2 further comprising underwriting said individual person if said determination of risk certification is to certify.

4. The method of claim 1 further comprising documenting reasons for not certifying said individual person if said determination of risk certification is not to certify.

5. The method of claim 4 further comprising investigating said reasons for not certifying said individual person and thereby generating investigative results.

6. The method of claim 5 further comprising inputting second information from said investigative results, said personal financial disclosure statement, said personal financial records, and said other relevant financial data into said risk assessment algorithm.

7. The method of claim 6 further comprising:
said risk assessment algorithm operating on said second input information and thereby generating second risk assessment data; and
evaluating said second risk assessment data and thereby making an updated determination of risk certification with respect to said individual person.

8.-26. (canceled)

27. A method to help deter fraud within an organization, said method comprising:
obtaining a personal financial disclosure statement of each of a plurality of individual persons associated with said organization;
obtaining personal financial records and other relevant financial data of each of said individual persons;
inputting first information from each of said personal financial disclosure statements, each of said personal financial records, and each of said other relevant financial data into a risk assessment algorithm;
said risk assessment algorithm operating on said first input information and thereby generating first risk assessment data; and
evaluating said first risk assessment data and thereby making a first determination of risk certification with respect to said organization.

28. The method of claim 28 further comprising certifying said organization if said determination of risk certification is to certify.

29. The method of claim 27 further comprising underwriting said organization if said determination of risk certification is to certify.

30. The method of claim 27 further comprising documenting reasons for not certifying said organization if said determination of risk certification is not to certify.

31. The method of claim 30 further comprising investigating said reasons for not certifying said organization and thereby generating investigative results.

32. The method of claim 31 further comprising inputting second information from said investigative results, said personal financial disclosure statements, said personal financial records, and said other relevant financial data into said risk assessment algorithm.

33. The method of claim 32 further comprising:
said risk assessment algorithm operating on said second input information and thereby generating second risk assessment data; and
evaluating said second risk assessment data and thereby making an updated determination of risk certification with respect to said organization.

34.-52. (canceled)

53. A method to monitor an individual person of an organization for behavioral risk, said method comprising:
periodically obtaining updated personal financial records and other updated relevant financial data of an individual person that is currently certified for risk with respect to said organization;
inputting, into a risk assessment algorithm, updated information from said updated personal financial records and other updated relevant financial data along with previous information from a previously obtained personal financial disclosure statement from said individual person;
said risk assessment algorithm operating on said input information and thereby generating updated risk assessment data; and
evaluating said updated risk assessment data and thereby making an updated determination of risk certification with respect to said individual person.

54. The method of claim 53 further comprising maintaining said risk certification of said individual person if said determination of risk certification is to maintain certification.

55. (canceled)

56. The method of claim 53 further comprising documenting reasons for not maintaining certification of said individual person if said determination of risk certification is not to maintain certification.

57. The method of claim 56 further comprising investigating said reasons for not maintaining certification of said individual person and thereby generating investigative results.

58. The method of claim 57 further comprising inputting second information from said investigative results, said personal financial disclosure statement, said updated personal financial records, and said updated other relevant financial data into said risk assessment algorithm.

59. The method of claim 58 further comprising:
said risk assessment algorithm operating on said second input information and thereby generating investigation-based risk assessment data; and
evaluating said investigation-based risk assessment data and thereby making an investigated determination of risk certification with respect to said individual person.

60.-78. (canceled)
